(19) United States
(12) Patent Application Publication
(10) Pub. No.: US 2003/0146661 A1
(43) Pub. Date: Aug. 7, 2003

(54) Pressure protection manifold

(75) Inventor: Chad Kenneth Hatch, Greensboro, NC (US)

Correspondence Address: WATTS, HOFFMANN, FISHER & HEINKE CO., L.P.A., P.O. Box 99839, Cleveland, OH, 44199-0830, US

(73) Assignee: VOLVO TRUCKS NORTH AMERICA, INC.

(21) Appl. No.: 10/061,687

(22) Filed: Feb. 1, 2002

(51) Int. Cl. B60T 8/36

(52) U.S. Cl. 303/119.3

(57) ABSTRACT

A one piece pressure protection valve and manifold. The valve and manifold includes a housing that defines an inlet passage and a plurality of outlet passages. A valve is included in the housing. The valve is interposed between the inlet passage and the outlet passages. The valve is constructed to prevent fluid flow from the inlet passage to the outlet passages when a fluid pressure at the inlet passage is below a predetermined value.

### FIELD OF THE INVENTION

This disclosure relates in general to air brake pressure protection and, more specifically, to a one piece pressure protection valve and manifold for a brake air system.

### BACKGROUND OF THE INVENTION

Air brakes of vehicles, such as over the highway trucks, are selectively engaged and disengaged by selectively providing air under pressure from an air tank to the air brakes. Auxiliary air powered or assisted systems include air springs of a rear suspension or cab suspension, a clutch, a transmission, an air horn, an air seat, and a fan clutch. These auxiliary systems are actuated or assisted by providing pressurized air from the air tank to the system. It is known to provide a pressure protection valve on the air tank to prevent loss of air pressure to the air brakes when one of the auxiliary systems leakage fails. The pressure protection valve closes off the supply of air from the tank to the auxiliary systems when pressure drops as a result of a leakage or failure of an auxiliary system. For example, air pressure drops when an air spring ruptures or leaks. An air valve closes the connection between the air tank and the air spring in response to the reduced air pressure to prevent air pressure to the air brakes from being lost.

FIGS. 2 through 4 illustrate one existing system 1. A threaded pressure protection valve 2 is mounted to an air tank 3. Referring to FIG. 3, the valve 2 includes two female threaded ports (one port visible in FIG. 3). A fitting 4 is threaded into each port. One port is connected directly to a component, such as an air seat. The other port is connected to a distribution manifold 5. Referring to FIG. 5, the distribution manifold is a plastic molded block having six push to connect cartridge fittings. One port is used for input 6 and the remaining ports are connected to vehicle systems. For some over the highway trucks, a second manifold is required.

The existing system has several connections that are potential leak points. In addition, the existing system includes several threaded connections that each increase assembly costs.

There is a need for a one piece valve and distribution manifold. A one piece valve and distribution manifold replaces a valve, two fittings, one or more distribution manifolds, and associated bracketry. A one piece distribution manifold would reduce the number of leak points and reduce the weight and cost of the pressure protection system.

### BRIEF DESCRIPTION OF THE DRAWINGS

FIG. 1 is a side elevational view of an over the highway tractor;

FIG. 2 is a schematic illustration of a prior art air brake pressure protection system;

FIG. 3 is a perspective view of a prior art pressure protection valve;

FIG. 4 is a top plan view, partially in section, of a prior art manifold;

FIG. 5A is a schematic representation of a one piece pressure protection valve and manifold with the valve in an open position;

FIG. 5B is a schematic representation of a one piece pressure protection valve and manifold with the valve in a closed position;

FIG. 6 is a perspective view of a one piece pressure protection valve and manifold;

FIG. 7 is a bottom plan view of a one piece pressure protection valve and manifold;

FIG. 8 is an elevational view taken across lines 8-8 of FIG. 7;

FIG. 9 is an elevational view taken across lines 9-9 of FIG. 7;

FIG. 10 is an elevational view taken across lines 10-10 of FIG. 8;

FIG. 11 is an elevational view taken across lines 11-11 of FIG. 8; and,

FIG. 12 is a schematic illustration of a pressure protection system for air brakes using a one piece pressure protection valve and manifold.

### SUMMARY OF THE INVENTION

The present disclosure is directed to a one piece pressure protection valve and manifold. The one piece pressure protection valve and manifold includes a housing that defines an inlet passage and a plurality of outlet passages. A valve is in the housing that is interposed between the inlet passage and the outlet passages. The valve is constructed to prevent fluid flow from the inlet passage to the outlet passage when a fluid pressure at the inlet passage is below a predetermined value.

In one embodiment, the valve comprises a piston that is biased toward the inlet by a spring. In the biased position, the piston prevents fluid flow from the inlet passage to the outlet passages. The piston remains in the biased position until fluid pressure at the inlet exceeds the biasing force of the spring. In one embodiment, the valve closes on decreasing pressure in the housing between about 62 and 72 psig and opens on rising inlet pressure between 75 and 95 psig.

In embodiments of the invention, the housing defines a vent in communication with the piston that prevents fluid pressure from building up between the piston and the interior of the housing. The inlet and outlet of the one piece pressure protection valve and manifold may each include push to connect cartridge fittings. In one embodiment, the inlet includes a ½ inch push to connect cartridge fitting, there are three ¼ inch push to connect cartridge fittings and four ⅜ inch push to connect cartridge fittings.

The one piece pressure protection valve and manifold may be used in a system for preventing air pressure loss to a vehicle air brake system. The system includes an air tank, an inlet air tube, a one piece pressure protection valve, and outlet air tubes. The inlet air tube has a first end that is connected to the air tank. The outlet air tubes each have a first end connected to one of the outlet passages of the one piece pressure protection valve and manifold. A second end of each of the outlet air tubes is connected to an air powered vehicle accessory.

Examples of air powered vehicle accessories include an air horn, an air seat, a fan clutch, a air spring, a cab suspension, a transmission, a clutch assist, and a rear suspension. In one embodiment, a ⅜ inch outlet is connected to a rear suspension, a ⅜ inch outlet is connected to the clutch assist, a ⅜ inch outlet is connected to a transmission, a ⅜ inch outlet is connected to an air horn, a ¼ inch outlet is connected to an air seat, a ¼ inch outlet is connected to a fan clutch and a ¼ inch outlet is connected to a cab suspension.

In one embodiment, the one piece pressure protection valve and manifold is used by connecting it to a source of fluid pressure. The outlets of the one piece pressure protection valve are connected to a plurality of air driven accessories. A passage between the inlet and outlets of the one piece pressure protection valve and manifold are opened when fluid pressure applied to the valve is greater than the predetermined value. The passage between the inlet and the outlets is closed when the fluid pressure is less than the predetermined value to prevent air pressure loss to the air brakes.

The disclosed one piece distribution manifold and pressure protection valve reduce the number of leak points of a air brake pressure protection system. In addition, the weight and cost of the pressure protection system is reduced.

Additional features of the invention will become apparent and a fuller understanding will be obtained by reading the following detailed description in connection with the accompanying drawings.

### DETAILED DESCRIPTION OF THE INVENTION

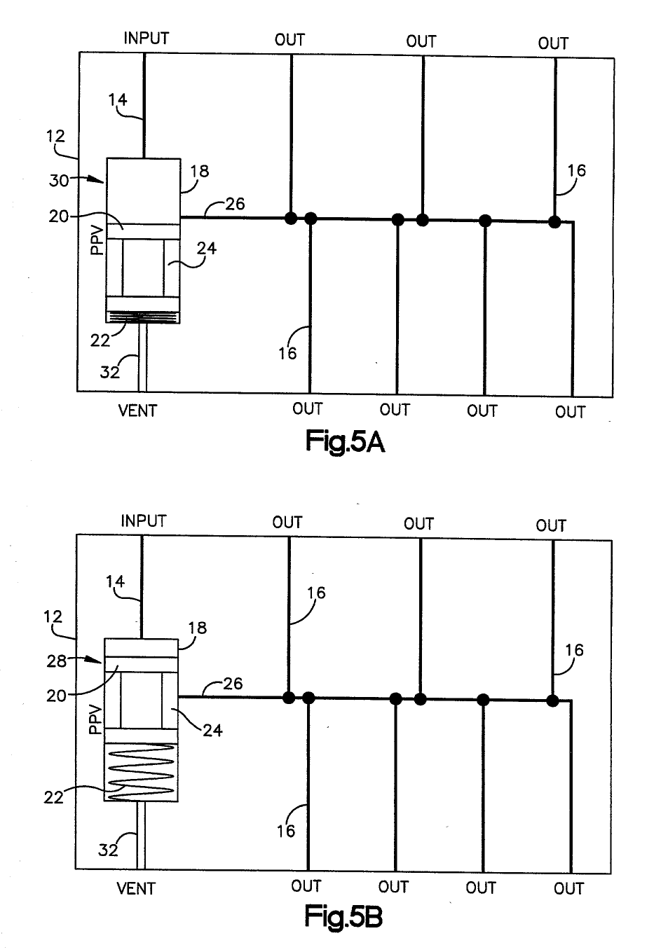

The present disclosure is directed to a one piece pressure protection valve and manifold 10. The pressure protection valve and manifold 10 includes a housing 12 that defines an inlet passage 14 and a plurality of outlet passages 16. A valve 18 (shown schematically in FIGS. 5A and 5B) is disposed in the housing between the inlet passage 14 and the outlet passages 16. The valve 18 is constructed to prevent fluid flow from the inlet passage 14 to the outlet passage 16 when fluid pressure at the inlet passage 14 drops below a predetermined value.

Referring to FIGS. 5A and 5B, the illustrated valve 18 includes a piston 20 and a 25 spring 22. The piston 20 is slidably disposed in a cylinder 24 defined in the interior of the housing 12. The spring 22 is constrained between an interior surface of the cylinder 24 and the piston 20.

FIG. 5B illustrates the biased or closed position 28 of the valve. The spring 22 biases the piston 20 to block a passage 26 to the outlet passages 16 when fluid pressure provided at the inlet is less than the biasing force of the spring 22. In the biased position 28, the piston 20 prevents fluid flow from the inlet passage 14 to the outlet passages 16.

FIG. 5A illustrates the valve 18 in an open position 30. The piston 20 is moved against the biasing force of the spring 22 to the open position 30 when the fluid pressure at the inlet passage 14 is sufficient to overcome the biasing force of the spring 22. The piston 20 is moved to a position where fluid can flow from the inlet passage 14 through the passage 26 to the outlet passages 16.

The illustrated housing 12 defines a vent 32 between the cylinder 24 and the exterior of the housing 12. The vent 32 prevents a build-up of pressure between the piston 20 and the interior of the housing 12 to prevent the piston from becoming stuck in the biased or closed position 28.

The illustrated pressure protection valve 10 opens on rising inlet pressure between 75 and 95 psig. The illustrated pressure protection valve and manifold 10 closes on decreasing pressure between about 62 and 72psig. It should be readily apparent to those skilled in the art that the valve 18 of the pressure protection and manifold 10 can be modified to open and close at any selected pressure range.

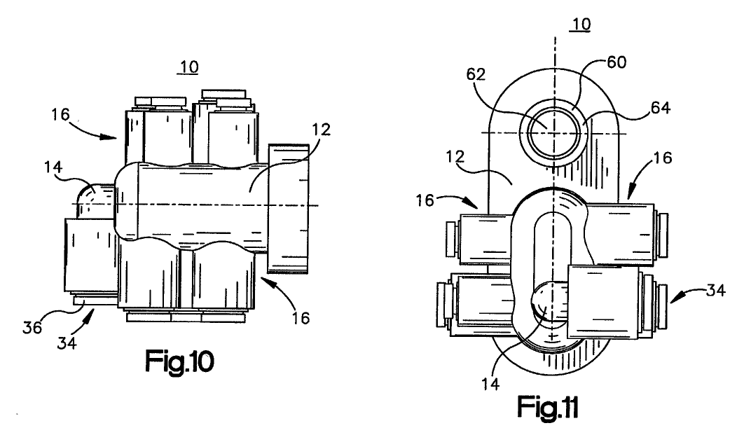

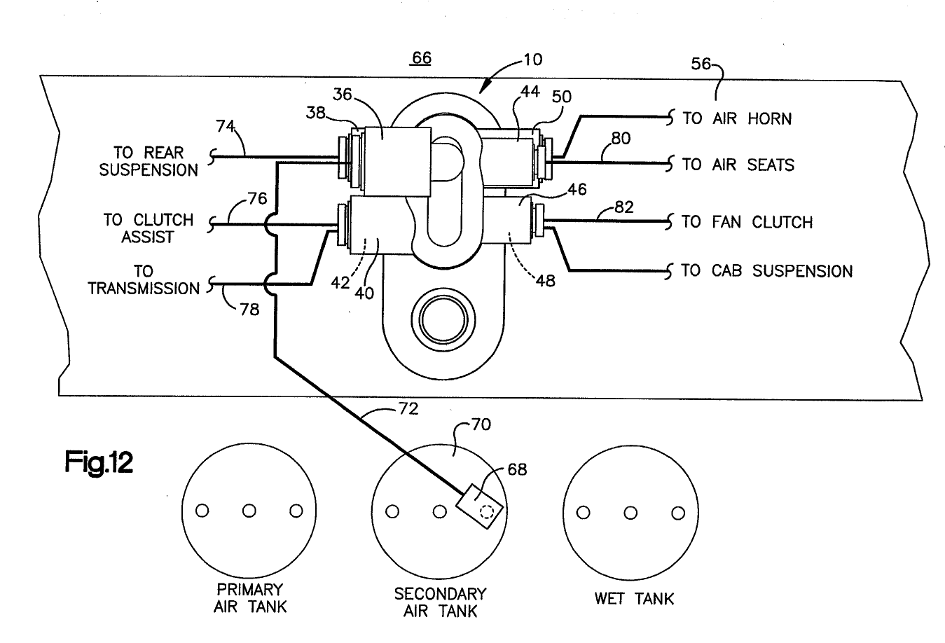

Referring to FIGS. 6-11, the illustrated pressure protection valve and manifold 10 includes push to connect cartridge fittings 34 on the inlet 14 and each of the outlets 16. The illustrated inlet passage 14 includes a ½ inch push to connect cartridge fitting 36.

Referring to FIG. 8, in the illustrated embodiment three outlet passages are accessible on one side of the housing through ⅜ inch push to connect cartridge fittings 38, 40, 42. Referring to FIG. 9, in the illustrated embodiment three outlet passages are accessible through a ¼ inch to push to connect cartridge fittings 44, 46, 48 and one outlet passage is accessible through a ⅜ inch push to connect cartridge fitting 50.

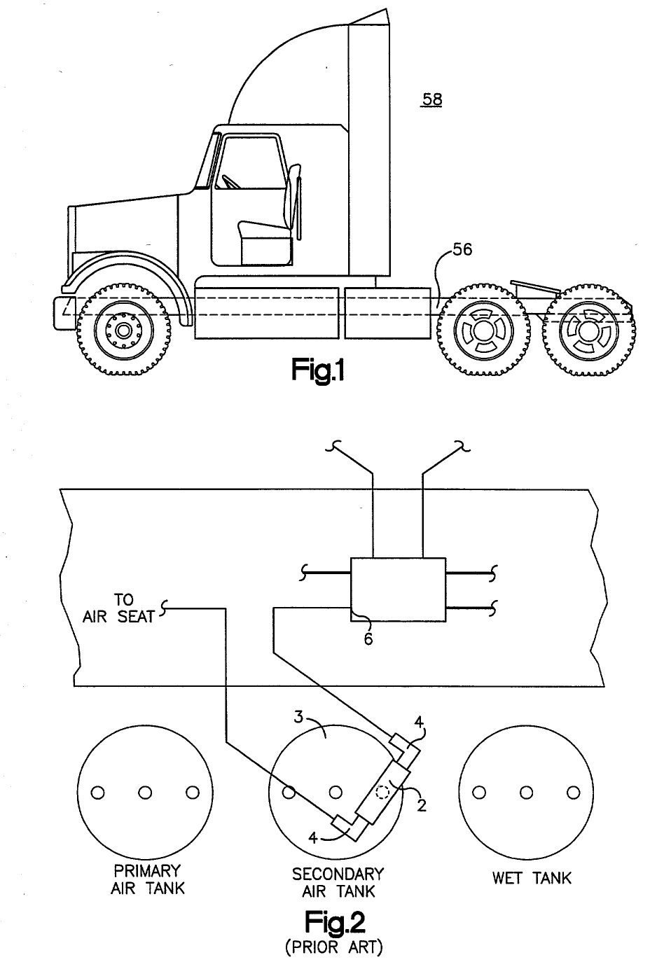

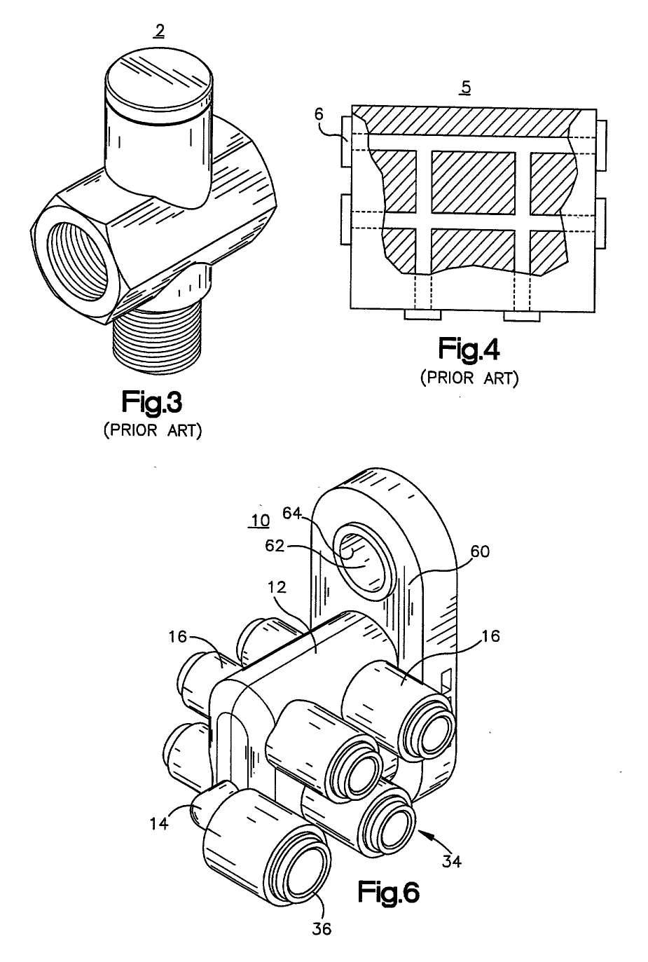

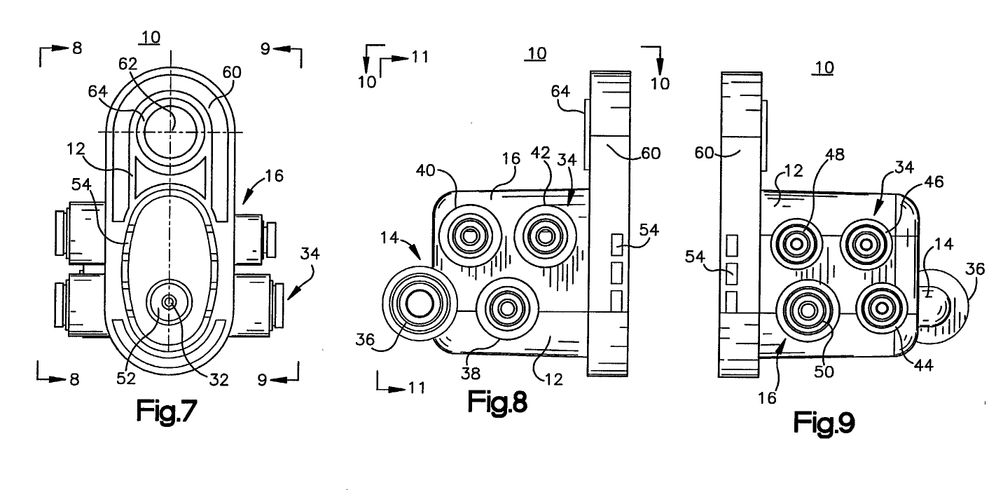

Referring to FIG. 7, the illustrated vent 32 includes a splash shield 52. Referring to FIGS. 7, 8 and 9, the housing 12 includes openings 54 that allow fluid exhausted through the vent 32 to escape from the housing 12 when the housing 12 is mounted to a surface, such as a frame rail 56 of a vehicle 58 (FIGS. 1 and 12).

In the illustrated embodiment, the one piece pressure protection valve and manifold 10 includes a mounting flange 60. A mounting hole 62 is defined in the mounting flange 60. In the illustrated embodiment, a steel liner 64 surrounds the mounting hole 62 to support a bolt load.

FIG. 12 illustrates use of the pressure protection valve and manifold 10 in a system 66 that provides pressure protection for an air brake system. A one piece pressure protection valve and manifold 10 is bolted to a frame rail 56 of a vehicle 58, such as an over the highway tractor (shown in FIG. 1). A fitting 68 is connected to an air tank 70. An inlet air tube 72 is connected at one end to the fitting 68 on the tank 70. The second end of the inlet air tube 72 is connected to the ½ inch push to connect cartridge fitting 36 of the inlet 14. In the illustrated embodiment, the ⅜ inch push to connect cartridge fittings 38, 40, 42 on one side of the housing 12 are connected to a ⅜ inch tube 74 that extends to the rear suspension, a ⅜ inch tube 76 that extends to the clutch assist and a ⅜ tube 78 that extends to the transmission. The ¼ inch push to connect cartridge fittings 44, 46, 48 of the second side of the housing 12 are connected to a ¼ inch tube 80 that extends to the air seats, a ¼ tube 82 that extends to the fan clutch, and a ¼ inch tube 84 that extends to the cab suspension. The ⅜ inch push to connect cartridge fitting 50 on the second side of the housing 12 is connected to a ⅜ inch tube 86 that extends to the air horn.

In operation, the system 66 prevents air pressure loss to air brakes of the vehicle 58 when one of the other air driven components, such as an air spring, a rear suspension, a clutch assembly, a transmission, an air seat, a fan clutch, a cab suspension, or an air horn leaks or is damaged. In normal operation, sufficient pressure is supplied from the air tank 70 to the inlet 14 to maintain the valve 18 in the open position 30, such that air under pressure is supplied from the air tank 70 to the air driven components. When one of the air driven components or the lines from the pressure protection valve and manifold to the air driven components are damaged, such that an air leak occurs, pressure inside the pressure protection valve and manifold drops. The drop in pressure causes the valve 18 to close. When the valve 18 is in the closed position 28, air is prevented from passing through the pressure protection valve and manifold 10 to the leak point. By stopping the supply of air from the tank 70 to the point of the leak, the air pressure for the brake air system is protected.

Although the present invention has been described with a degree of particularity, it is the intent that the invention include all modifications and alterations falling within the spirit or scope of the appended claims.

I claims:

1. A one piece pressure protection valve and manifold, comprising:
a) a housing defining an inlet passage and at least three outlet passages;
b) a valve in said housing interposed between said inlet passage and said outlet passages, said valve being constructed to prevent fluid flow from said inlet passage to said outlet passages when a fluid pressure at said inlet passage is below a predetermined value.

2. The one piece pressure protection valve and manifold of claim 1 wherein said valve comprises a piston biased toward said inlet by a spring to prevent said fluid flow from said inlet passage to said outlet passages when said fluid pressure at said inlet passage is less than a biasing force of said spring.

3. The one piece pressure protection valve and manifold of claim 2 further comprising a vent defined by said housing in communication with said piston.

4. The one piece pressure protection valve and manifold of claim 1 wherein said valve closes on decreasing pressure between about 62 and 72 PSIG.

5. The one piece pressure protection valve and manifold of claim 1 wherein said valve opens on rising inlet pressure between 75 and 95 PSIG.

6. The one piece pressure protection valve and manifold of claim 1 wherein inlet and said outlets each include push to connect cartridge fittings.

7. The one piece pressure protection valve and manifold of claim 1 wherein said inlet includes a ½ inch push to connect cartridge fitting and said outlet passages comprise seven outlet passages wherein three of said outlet passages include ¼ inch push to connect cartridge fittings and four of said outlet passages include ⅜ inch push to connect cartridge fittings.

8. A one piece pressure protection valve and manifold, comprising:
a) a housing defining an inlet passage, a plurality of outlet passages and a vent;
b) a valve in said housing interposed between said inlet passage and said outlet passages, said valve comprises a piston biased toward said inlet by a spring, said vent prevents a build up of pressure between said piston and an interior of said housing, said valve closes on decreasing pressure between about 62 and 72 PSIG and opens on rising inlet pressure between 75 and 95 PSIG;
c) a push to connect cartridge fitting of a first size on said inlet; and
d) push to connect cartridge fittings of a different size or different sizes on said outlets.

9. The one piece pressure protection valve and manifold of claim 8 wherein said inlet push to connect cartridge fitting is a ½ inch fitting and said plurality of outlet passages comprise seven outlet passages wherein three of said outlet passages include ¼ inch push to connect cartridge fittings and four of said outlet passages include ⅜ inch push to connect cartridge fittings.

10. A system for preventing air pressure loss to vehicle air brakes, comprising:
a) an air tank for supplying air under pressure;
b) an inlet air tube having a first end connected to said air tank and a second end;
c) a one piece pressure protection valve and manifold that includes:
i) a housing defining an inlet passage connected to said second end of said inlet air tube and at least three outlet passages;
ii) a valve in said housing interposed between said inlet passage and said outlet passages, said valve being constructed to prevent fluid flow from said inlet passage to said outlet passages when a fluid pressure at said inlet passage is below a predetermined value; and
d) outlet air tubes each having a first end connected to one of said outlet passages and a second end connected to an air powered vehicle accessory.

11. The system of claim 10 wherein one of said air powered accessories is an air horn.

12. The system of claim 10 wherein one of said air powered accessories is an air seat.

13. The system of claim 10 wherein one of said air powered accessories is fan clutch.

14. The system of claim 10 wherein one of said air powered accessories is a cab suspension.

15. The system of claim 10 wherein one of said air powered accessories is a transmission.

16. The system of claim 10 wherein one of said air powered accessories is a clutch assist.

17. The system of claim 10 wherein one of said air powered accessories is a rear suspension.

18. The system of claim 10 wherein one of said air powered accessories is an air spring.

19. The system of claim 10 wherein said valve comprises a piston biased toward said inlet by a spring to prevent said fluid flow from said inlet passage to said outlet passages when said fluid pressure at said inlet passage is less than a biasing force of said spring.

20. The system of claim 10 wherein said valve closes on decreasing pressure between about 62 and 72 PSIG.

21. The system of claim 10 wherein said valve opens on rising inlet pressure between 75 and 95 PSIG.

22. The system of claim 10 wherein inlet and said outlets each include push to connect cartridge fittings.

23. The system of claim 10 wherein said inlet includes a ½ inch push to connect cartridge fitting and said outlet passages comprise seven outlet passages wherein three of said outlet passages include ¼ inch push to connect cartridge fittings and four of said outlet passages are ⅜ inch push to connect cartridge fittings.

24. A system for preventing air pressure loss to vehicle air brakes, comprising:
a) an air tank for supplying air under pressure;
b) an inlet air tube having a first end connected to said air tank and a second end;
c) a one piece pressure protection valve and manifold, that includes:
i) a housing defining an inlet passage connected to said second end of said inlet tube, a plurality of outlet passages and a vent;
ii) a valve in said housing interposed between said inlet passage and said outlet passages, said valve comprises a piston biased toward said inlet by a spring, said vent prevents a build up of pressure between said piston and an interior of said housing, said valve closes on decreasing pressure between about 62 and 72 PSIG and opens on rising inlet pressure between 75 and 95 PSIG;
iii) a push to connect cartridge fitting of a first size on said inlet;
iv) push to connect cartridge fittings of a different size or different sizes than said first size on said outlets; and
d) outlet air tubes each having a first end connected to one of said outlet passages and a second end connected to an air powered vehicle accessory.

25. The system of claim 24 wherein said housing includes a ½ inch push to connect cartridge inlet, four ⅜″ push to connect cartridge outlets, and three ¼″ push to connect cartridge outlets.

26. The system of claim 25 wherein one ⅜ inch outlet is connected to a rear suspension, one ⅜ inch outlet is connected to a clutch assist, one ⅜ inch outlet is connected to a transmission, one ⅜″ outlet is connected to an air horn, one ¼ inch outlet is connected to an air seat, one ¼ inch outlet is connected to a fan clutch, and one ¼ inch outlet is connected to a cab suspension.

27. A method of preventing air pressure loss to vehicle air brakes, comprising:
a) connecting an inlet of a one piece pressure protection valve and manifold to a source of fluid pressure;
b) connecting outlets of said one piece pressure protection valve and manifold to a plurality of air driven accessories;
c) opening a passage between said inlet and said outlets when a fluid pressure applied to a valve of said one piece pressure protection valve is greater than a first predetermined value; and
d) closing a passage between said inlet and said outlets when said fluid pressure is less than a second predetermined value to prevent air pressure loss to air brakes.

28. The method of claim 27 wherein a piston of said valve biased toward said inlet by a spring to close said passage.

29. The method of claim 27 wherein said passage is closed on decreasing pressure between about 62 and 72 PSIG.

30. The method of claim 27 wherein said passage is opened on rising inlet pressure between 75 and 95 PSIG.

31. The system of claim 27 wherein one of said air driven accessories is an air spring and said passage is closed when said air spring leaks.

32. The system of claim 27 wherein one of said air driven accessories is a cab suspension and said passage is closed when said cab suspension leaks.

33. The system of claim 27 wherein one of said air driven accessories is a rear suspension and said passage is closed when said cab suspension leaks.
